(19) United States
(12) Patent Application Publication
(10) Pub. No.: US 2011/0109526 A1
(43) Pub. Date: May 12, 2011

(54) MULTI-SCREEN IMAGE DISPLAY

(75) Inventors: Judit Martinez Bauza, San Diego, CA (US); Thomas E. Kilpatrick, II, San Diego, CA (US); Sten Jorgen Ludvig Dahl, San Diego, CA (US)

(73) Assignee: QUALCOMM Incorporated, San Diego, CA (US)

(21) Appl. No.: 12/941,867

(22) Filed: Nov. 8, 2010

Related U.S. Application Data
(60) Provisional application No. 61/259,329, filed on Nov. 9, 2009.

(51) Int. Cl. G09G 5/00

(52) U.S. Cl. 345/1.3

(57) ABSTRACT

Techniques are described for displaying information over multiple display panels. The appearance of multiple points-of-view may be used to display information that would not be displayed because the information corresponds to a gap between the display panels. The appearance of multiple points-of-view may be provided such that information not displayed in one point-of-view is displayed in another point-of-view.

### CROSS-REFERENCES TO RELATED APPLICATIONS

This application claims priority to U.S. Provisional Patent Application No. 61/259,329, filed Nov. 9, 2009, entitled “Display of Images Across Multiple Screens,” Attorney Docket No. 093459P1, the entire disclosure of which is hereby incorporated by reference for all purposes.

### BACKGROUND

Multiple display panels are often used to provide users of electronic devices with increased functionality. For instance, a user may have multiple monitors connected with a computer. Such an arrangement may allow the user to view multiple items at the same time and/or information spanning the multiple monitors. Typically, the display panels of the multiple monitors are not immediately adjacent to each other. For instance, even if two monitors are placed directly next to each other, each monitor typically has a frame around its display panel. Therefore, when two such monitors are placed directly adjacent such that the frames are touching, there is a region between the two display panels that does not display information. As the monitors are moved apart, this region that does not display information grows.

Typically, a region between display panels where information cannot be displayed is ignored by the electronic device driving the display panels. Therefore, as information is moved beyond the boundary of the first display panel toward a second display panel, the information becomes visible on the second display panel. This may result in visual distortion. Information, such as a graphic or text, displayed spanning both the first and second display screens may have its boundary dimensions altered due to the ignored gap between the first display panel and the second display panel. For instance, a graphic that is two inches wide when displayed on a single display panel, may appear to be three inches wide when the graphic is displayed spanning two display panels with a gap between the display panels an inch wide. Such distortion may also occur when other numbers of display panels, greater than one, are present. Distortion may occur regardless of whether the display panels are vertically aligned, horizontally aligned, or arbitrarily arranged.

### SUMMARY

An example of system includes: a processor configured to be communicatively coupled to a first display panel and to a second display panel, the second display panel being located a first distance from the first display panel, where the processor is configured to: display, using the first display panel and the second display panel, a first portion of a set of information over a display region spanning at least part of the first display panel and spanning at least part of the second display panel, where: the set of information has boundary dimensions; the first portion excludes a second portion of the set of information corresponding to a gap region between the first panel and the second panel, with the first portion having the boundary dimensions.

Implementations of such a system may include one or more of the following features. The processor is further configured to: display, using the first display panel and the second display panel, a third portion of the set of information over the display region spanning at least part of the first display panel and at least part of the second display panel, where: the third portion of the set of information excludes a fourth portion of the set of information corresponding to the gap region between the first display panel and the second display panel with the third portion having the boundary dimensions; and the fourth portion of the set of information and the second portion are at least partially different portions of the set of information. The processor is further configured to: display, using the first display panel and the second display panel, a first graphic while displaying the first portion, where the first graphic indicates a first point-of-view; and display, using the first display panel and the second display panel, a second graphic while displaying the third portion, where the second graphic indicates a second point-of-view that is different from the first point-of-view. The first graphic displayed while displaying the first portion provides an appearance of the first point-of-view; and the second graphic displayed while displaying the third portion provides an appearance of the second point-of-view. The fourth portion and the second portion are exclusively different portions of the set of information, the third portion comprises at least some of the information of the second portion, and the fourth portion comprises at least some of the information of the first portion.

Implementations of such a system may also, or alternatively, include one or more of the following features. The system further includes a point-of-view trigger device communicatively coupled with the processor, where the point-of-view trigger device is configured to provide an indication to the processor, and the processor is configured to use the indication to determine whether to display the first portion of the set of information or to display the third portion of the set of information. The point-of-view triggering device is an accelerometer. The point-of-view triggering device comprises at least one of a retina tracking device, a touchpad, a touch screen, a keyboard, or a button.

Implementations of such a system may also, or alternatively, include one or more of the following features. The processor is further configured to: display the first portion over the display region spanning the first display panel, the second display panel, and a third display panel located a second distance from the second display panel, where the second portion further comprises information corresponding to a second gap region between the second display panel and the third panel; and display the third portion over the display region spanning the first display panel, the second display panel, and the third display panel, where the fourth portion further comprises information corresponding to the second gap region between the second display panel and the third panel. The processor is further configured to: receive an input; determine the first distance from the first display panel to the second display panel using the input; and determine information in the third portion and information in the fourth portion based on the first distance. The system comprises a mobile telecommunications device and where the first and second display panels are movably connected such that the first display panel can be moved from a first position coplanar with the second display panel to a second position overlying the second display panel.

An example of a method for displaying information includes: displaying, using a first display panel and a second display panel, a first portion of a set of information over a display region spanning at least part of the first display panel and spanning at least part of the second display panel, the first display panel located a first distance from the second display panel, where: the set of information has boundary dimensions; the first portion excludes a second portion of the set of information corresponding to a gap region between the first panel and the second panel, with the first portion having the boundary dimensions.

Implementations of such a system may include one or more of the following features. The method further includes: displaying, using the first display panel and the second display panel, a third portion of the set of information over the display region spanning at least part of the first display panel and at least part of the second display panel, where: the third portion of the set of information excludes a fourth portion of the set of information corresponding to the gap region between the first display panel and the second display panel with the third portion having the boundary dimensions; and the fourth portion of the set of information and the second portion are at least partially different portions of the set of information. The method further includes: displaying, using the first display panel and the second display panel, a first graphic while displaying the first portion, where the first graphic indicates a first point-of-view; and displaying, using the first display panel and the second display panel, a second graphic while displaying the third portion, where the second graphic indicates a second point-of-view that is different from the first point-of-view. The first graphic is displayed while displaying the first portion provides an appearance of the first point-of-view, and the second graphic is displayed while displaying the third portion provides an appearance of the second point-of-view. The fourth portion and the second portion are exclusively different portions, the third portion comprises at least some of the information of the second portion, and the fourth portion comprises at least some of the information of the first portion. The method further includes receiving an indication from a point-of-view trigger device, and selecting the third portion of the set of information based on the indication. The method further includes detecting an acceleration, and providing the indication indicating a direction and magnitude of the acceleration. The method further including: displaying the first portion over the display region spanning the first display panel, the second display panel, and a third display panel located a second distance from the second display panel, where the second portion further comprises information corresponding to a second gap region between the second display panel and the third panel; and displaying the third portion over the display region spanning the first display panel, the second display panel, and the third display panel, where the fourth portion further comprises information corresponding to the second gap region between the second display panel and the third panel. The method further includes receiving an input, determining the first distance from the first display panel to the second display panel using the input, and determining information in the third portion and information in the fourth portion using the first distance.

An example of a computer program product residing on a non-transitory processor-readable medium includes processor-readable instructions configured to cause a processor to: display, using a first display panel and a second display panel, a first portion of a set of information over a display region spanning at least part of the first display panel and spanning at least part of the second display panel, the first display panel located a first distance from the second display panel, where: the set of information has boundary dimensions; the first portion excludes a second portion of the set of information corresponding to a gap region between the first panel and the second panel, with the first portion having the boundary dimensions.

Implementations of such a computer program product may include one or more of the following features. The instructions further include instructions configured to cause the processor to: display, using the first display panel and the second display panel, a third portion of the set of information over the display region spanning at least part of the first display panel and at least part of the second display panel, where: the third portion of the set of information excludes a fourth portion of the set of information corresponding to the gap region between the first display panel and the second display panel with the third portion having the boundary dimensions; and the fourth portion of the set of information and the second portion are at least partially different portions of the set of information. Display a first graphic while displaying the first portion, where the first graphic indicates a first point-of-view; and display a second graphic while displaying the third portion, where the second graphic indicates a second point-of-view that is different from the first point-of-view. The first graphic displayed while displaying the first portion provides an appearance of the first point-of-view; and the second graphic displayed while displaying the third portion provides an appearance of the second point-of-view. The fourth portion of the set of information and the second portion of the set of information are exclusively different portions, the third portion of the set of information comprises at least some of the information of the second portion of the set of information, and the fourth portion of the set of information comprises at least some of the information of the first portion of the set of information. The instructions further include instructions configured to cause the processor to: display the first portion over the display region spanning the first display panel, the second display panel, and a third display panel located a second distance from the second display panel, where the second portion further comprises information corresponding to a second gap region between the second display panel and the third panel; and display the third portion over the display region spanning the first display panel, the second display panel, and the third display panel, where the fourth portion further comprises information corresponding to the second gap region between the second display panel and the third panel. The instructions further include instructions configured to cause the processor to: receive an input; determine the first distance using the input; and determine information in the third portion and information in the fourth portion using the first distance.

Another example of a system includes: means for displaying a first portion of a set of information over a display region spanning at least part of a first display panel and spanning at least part of a second display panel, the first display panel located a first distance from the second display panel, where: the set of information has boundary dimensions; the first portion excludes a second portion of the set of information corresponding to a gap region between the first panel and the second panel, with the first portion having the boundary dimensions.

Implementations of such a system may include one or more of the following features. The system includes means for displaying a third portion of the set of information over the display region spanning at least part of the first display panel and at least part of the second display panel, where: the third portion of the set of information excludes a fourth portion of the set of information corresponding to the gap region between the first display panel and the second display panel with the third portion having the boundary dimensions; and the fourth portion of the set of information and the second portion are at least partially different portions of the set of information. The system further includes means for displaying a first graphic while displaying the first portion of the set of information, where the first graphic indicates a first point-of-view, and means for displaying a second graphic while displaying the third portion of the set of information, where the second graphic indicates a second point-of-view that is different from the first point-of-view. The first graphic displayed while displaying the first portion provides an appearance of the first point-of-view; and the second graphic displayed while displaying the third portion provides an appearance of the second point-of-view. The fourth portion and the second portion are exclusively different portions, the third portion comprises at least some of the information of the second portion, and the fourth portion comprises at least some of the information of the first portion. The system further includes means for determining whether to display the first portion of the set of information or to display the third portion of the set of information. The system further includes: means for displaying the first portion over the display region spanning the first display panel, the second display panel, and a third display panel located a second distance from the second display panel, where the second portion further comprises information corresponding to a second gap region between the second display panel and the third panel; and means for displaying the third portion over the display region spanning the first display panel, the second display panel, and the third display panel, where the fourth portion further comprises information corresponding to the second gap region between the second display panel and the third panel. The system further includes: means for receiving an input; means for determining the first distance using the input; and means for determining information in the third portion and information in the fourth portion using the first distance. The system comprises a mobile telecommunication device.

An example of a multi-panel display system includes: a first display panel configured to display information; a second display panel configured to display information, where the second display panel is located a distance from the first display panel; and a processor communicatively coupled to the first display panel and the second display panel, where the processor is configured to: display, using the first display panel and the second display panel, a first portion of a set of information over a display region spanning at least part of the first display panel and spanning at least part of the second display panel, where: the set of information has boundary dimensions; the first portion excludes a second portion of the set of information corresponding to a gap region between the first panel and the second panel, with the first portion having the boundary dimensions.

Implementations of such a system may include one or more of the following features. The processor is further configured to: display, using the first display panel and the second display panel, a third portion of the set of information over the display region spanning at least part of the first display panel and at least part of the second display panel, where: the third portion of the set of information excludes a fourth portion of the set of information corresponding to the gap region between the first display panel and the second display panel with the third portion having the boundary dimensions; and the fourth portion of the set of information and the second portion are at least partially different portions of the set of information. Display a first graphic while displaying the first portion of the set of information, where the first graphic indicates a first point-of-view; and display a second graphic while displaying the third portion of the set of information, where the second graphic indicates a second point-of-view that is different from the first point-of-view. The first graphic displayed while displaying the first portion provides an appearance of the first point-of-view, and the second graphic displayed while displaying the third portion provides an appearance of the second point-of-view. The system further includes a point-of-view trigger device communicatively coupled with the processor, where the point-of-view trigger device is configured to provide an indication to the processor, and the processor is configured to use the indication to determine whether to display the first portion of the set of information or to display the third portion of the set of information. The point-of-view triggering device comprises at least one of an accelerometer, a retina tracking device, a touchpad, a touch screen, a keyboard, or a button. The system further includes a third display panel configured to display information, where the processor is further configured to: display the first portion over the display region spanning the first display panel, the second display panel, and a third display panel, where the second portion further comprises information corresponding to a second gap region between the second display panel and the third panel; and display the third portion over the display region spanning the first display panel, the second display panel, and the third display panel, where the fourth portion further comprises information corresponding to the second gap region between the second display panel and the third panel. The system comprises a mobile telecommunications device and the first display panel, the second display panel, and the third display panel are configured to be disposed in a coplanar relationship. The system further includes first and second housings, of the first and second display panels respectively, occupying at least a portion of the distance between the first display panel and the second display panel. The system further includes a plurality of display panels in addition to the first display panel and the second display panel. The first display panel, the second display panel, and the plurality of display panels are arranged one of linearly or in a two-dimensional array.

Items and/or techniques described herein may provide one or more of the following capabilities. A user viewing information spread over multiple display panels can be provided with the appearance of multiple points-of-view. These points-of-view result in display information being shifted such that information that was previously not displayed due to gaps between the display panels, being displayed. This allows the user to effectively use multiple display panels that have a gap between them with the user being able to view information that would otherwise not be displayed yet without distorting the information's dimensions, or slightly distorting the dimensions.

### BRIEF DESCRIPTION OF THE DRAWINGS

FIG. 1 is a perspective view of a cellular phone that has a multi-panel display.

FIG. 2 is a perspective view of a computer system with multiple monitors.

FIG. 3 is a plan view of a multi-display panel system having four display panels arranged in roughly a two-by-two arrangement.

FIG. 4 is a block diagram of a multi-panel computer system with multiple display panels.

FIG. 5A is a plan view of the multi-panel display system shown in FIG. 4 displaying a portion of a composite image and text.

FIG. 5B is one portion of the composite image and text displayed in FIG. 5A.

FIG. 5C is a portion of the composite image and text that is not displayed in FIG. 5A.

FIG. 5D is another portion of the composite image and text displayed in FIG. 5A.

FIG. 6A is a plan view of the multi-panel display system shown in FIG. 4 displaying another portion of the composite image.

FIG. 6B is one portion of the composite image and text displayed in FIG. 6A.

FIG. 6C is a portion of the composite image and text that is not displayed in FIG. 6A.

FIG. 6D is another portion of the composite image and text displayed in FIG. 6A.

FIG. 7 is a block flow diagram of a method for displaying information using a multi-panel display system.

FIG. 8 is a block flow diagram of another method for displaying information using a multi-panel display system.

### DETAILED DESCRIPTION

Techniques described herein provide various mechanisms for displaying information across multiple display panels. To reduce or eliminate distortion of information (such as graphics and text) displayed across multiple display panels, gaps between the display panels are compensated for. For example, a graphic that has dimensions of five inches by two inches when displayed using a single display screen remains approximately five inches by two inches when displayed across multiple display screens. As such, whether the graphic is displayed on one display panel or across multiple display panels, the graphic would retain the same dimensions.

Image information corresponding to gaps between display panels (i.e., would-be displayed information) is not displayed. Information omitted due to gaps between the display panels in one point-of-view is displayed in a different point-of-view. These points-of-view may be switched between by a user and allow the user to view some or all of the information that would otherwise not be displayed due to the gap between the display panels. For instance, if a graphic is displayed across two display panels, with a one inch gap between the panels, an inch wide portion of the graphic is not displayed in a first point-of-view. A second point-of-view is displayed where the portion of the graphic omitted in the first point-of-view is now displayed. A different portion of the graphic is thus omitted that corresponds to the gap between the display panels.

Besides computer monitors, many situations are present where a gap or gaps between display panels are present. For instance, some cellular phones have multiple display panels. Due to the configuration of the cellular phone, these display panels are not immediately adjacent each other. Rather, a frame, case, empty space, or some other object occupies region between the display panels. This region is unable to display information.

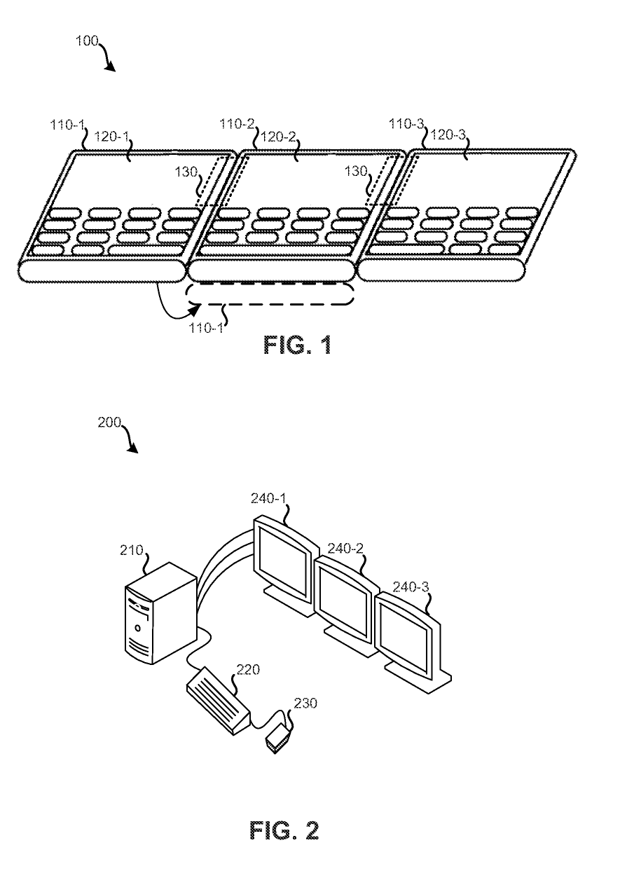

FIG. 1 illustrates an embodiment of a foldable cellular phone 100 that has a multi-panel display. Cellular phone 100 includes sections 110 and display panels 120. Display panels 120 include display panel 120-1 located on section 110-1, display panel 120-2 located on section 110-2, and display panel 120-3 located on section 110-3. Cellular phone 100 is configured such that sections 110-1 and 110-3 can be folded or moved from being coplanar with section 110-2 to being in an overlying relationship with section 110-2 (with section 110-1 shown in dashed lines in overlying relationship with section 110-2).

When display panels 120 display information, such as text and/or graphics, the information can either be displayed on a single display panel of display panels 120 or the information can span two or all three of display panels 120. When unfolded, display panel 120-1 is not immediately adjacent to display panel 120-2. Similarly, display panel 120-2 is not immediately adjacent to display panel 120-3. Gap regions 130, where information cannot be displayed, are present between display panel 120-1 and display panel 120-2 and between display panel 120-2 and display panel 120-3. Gap region 130 on cellular phone 100 includes a portion of the frame of cellular phone 100. The size of gap region 130 between display panels 120 is static due to display panels 120 being part of cellular phone 100. Therefore, for information to be displayed across multiple display panels of display panels 120 without distortion, multiple points-of-view are used to allow all of the information to be displayed. Cellular phone 100 represents an example of a cellular phone and other examples of cellular phones having multiple display panels with gap regions between the display panels are possible. Additionally, other forms of handheld devices having multiple display panels with gaps between the display panels, such as personal digital assistants, e-book readers, handheld televisions, tablet computers, etc. are possible.

Another situation where gaps are present between display panels is when multiple monitors that have frames are attached with the same computer. FIG. 2 illustrates an embodiment of a computer system 200 that is attached with multiple monitors. Computer system 200 includes tower 210, keyboard 220, and mouse 230. Computer system 200 also includes monitors 240, which include monitor 240-1, monitor 240-2, and monitor 240-3. Computer systems having two monitors or more than three monitors are also possible. Monitors 240 are positioned immediately adjacent to each other. Due to the frames of monitor 240, a gap region exists between the display panels of monitors 240.

While monitors 240 are located immediately adjacent to each other this may not always be true. Monitors 240 can be moved apart such that there is airspace (or an object) between monitors 240. This results in the gap region between the display panels being larger, and possibly different sizes/shapes of gap regions existing between different sets of monitors 240. Besides computer monitors, the use of other types of multiple display panels may result in gaps between display panels. For example, multiple television screens, movie screens, arena displays, and vehicular displays (e.g., navigation systems and instrumentation panels) may be used. Many arrangements of display panels where a gap is present between display panels exist now or may be produced in the future.

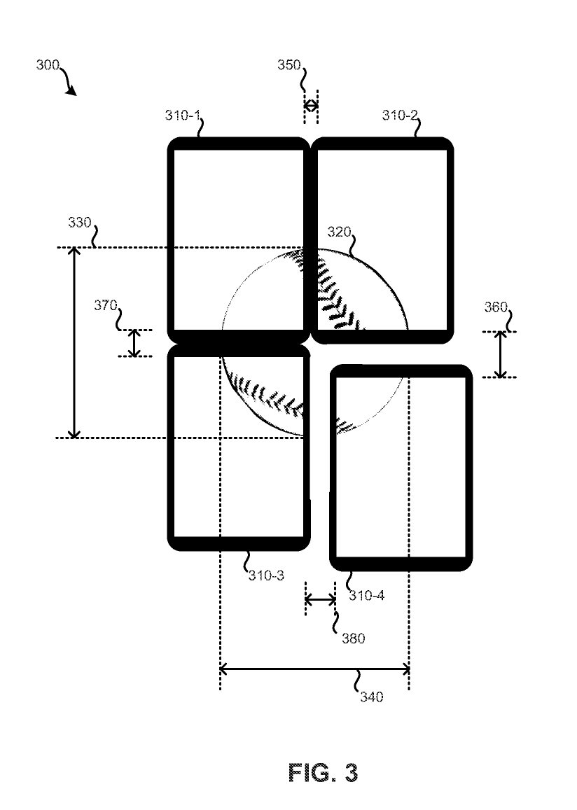

While display panels may be arranged linearly, display panels can also be arranged in arbitrary configurations. FIG. 3 illustrates a multi-display panel system 300 having four display panels arranged in roughly a two-by-two configuration. Multi-display panel system 300 includes display devices 310 (which includes display devices 310-1 through 310-4). Each of display devices 310 includes a frame or other form of border that entirely or partially encompasses the display panel of each display device 310. Each display panel is configured to display information. Therefore, when two display devices 310 are placed immediately adjacent to each other, whether arranged vertically, horizontally, or in some arbitrary configuration, a gap region will be present between the display panels.

As shown in FIG. 3, display devices 310-2 and 310-3 are immediately adjacent to display device 310-1. Display device 310-4 is located a greater distance from display device 310-2 and 310-3 than device 310-1. A gap region 370 is larger than gap region 350 because the frames of display devices 310 are greater on the top and bottom than on the sides. Gap regions 350, 370 are smaller than gap regions 380, 360 because display devices 310-1, 310-2, and 310-3 are immediately adjacent, while there is additional space between display devices 310-2 and 310-4 and between display devices 310-3 and 310-4.

An image 320 of a baseball spans all four display panels of display devices 310. Multi-panel display system 300 is configured such that the dimensions of image 320 do not change (or are substantially constant) regardless of whether image 320 is displayed on one, two, three, or all four of the display panels of display devices 310. Therefore, dimensions of image 320 (e.g., a height 330 and a width 340) will remain substantially unchanged regardless of the number of display panels used to display image 320 and regardless of the size of the various gap regions as long as corresponding gap regions 350, 360, 370, 380 remain constant or changes are accounted for. As such, if image 320 spans multiple display panels, one or more portions of image 320 are not visible. As illustrated, gap regions 350, 360, 370, and 380 each occupy positions corresponding to where a portion of image 320 would be displayed. As such, a user cannot view the entire image 320 at one time as long as image 320 spans multiple display panels. In order to allow a user to view the portions of image 320 that correspond to the locations of gap regions 350, 360, 370, 380, image 320 is shifted such that the user is presented with an appearance of a different point-of-view.

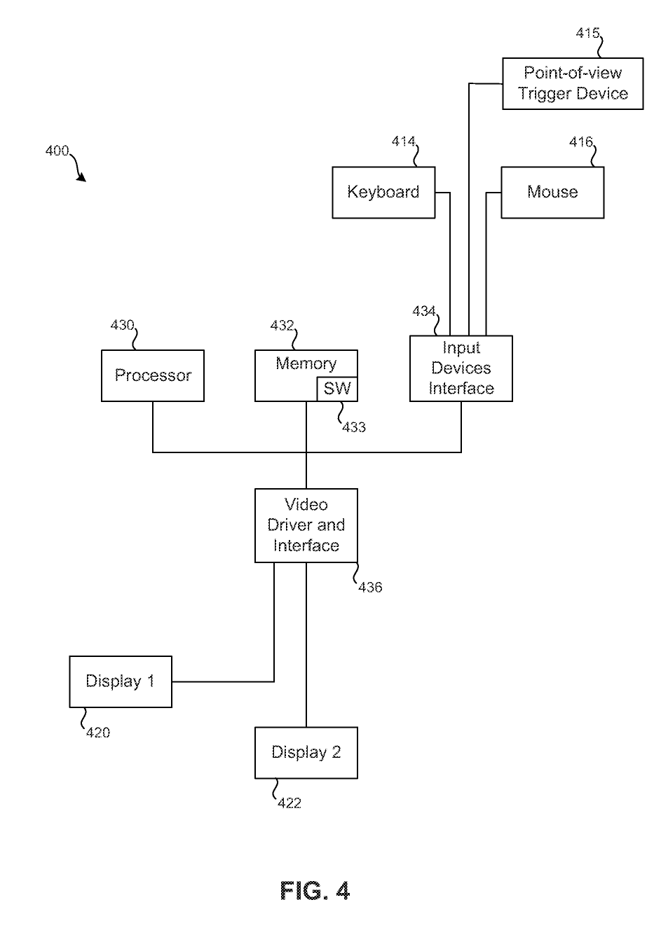

Display panels, such as the display panels of display devices 310 of FIG. 3, display panels of monitors 240 of FIG. 2, and display panels 120 of FIG. 1 may part a computerized system that drives what is displayed. Referring to FIG. 4, a computer system 400 includes a keyboard 414, a mouse 416, a point-of-view trigger device 415, a processor 430, memory 432, an input devices interface 434, a video driver and interface 436, and displays 420, 422. Other configurations than that shown are possible (e.g., without a physical keyboard or a mouse, e.g., for mobile phone configurations). The input devices interface 434 is connected to, and configured to receive input from, keyboard 414 and mouse 416 regarding, e.g., characters (letters, numbers, symbols) and selections (e.g., mouse clicks). The processor 430 is preferably an intelligent hardware device, e.g., a central processing unit (CPU) such as those made by INTEL® or AMD®, a microcontroller, an application specific integrated circuit (ASIC), etc. The memory 432 includes random access memory (RAM) and read-only memory (ROM). Memory 432 is non-transitory. The memory 432 preferably stores computer-readable, computer-executable software code 433 containing instructions that are configured to, when executed, cause the processor 430 to perform various functions described herein. Alternatively, the software 433 may not be directly executable by the processor 430 but is configured to cause the processor 430, e.g., when compiled and executed, to perform functions described. The video driver and interface 436 is connected to, and configured to provide information to, displays 420, 422 to display content on screens of the displays 420, 422 as described herein.

Another input device connected with input devices interface 434 is a point-of-view trigger device 415. Point-of-view trigger device 415 is used to determine when information displayed on displays 420, 422, and 424 is to be modified to provide the appearance of another point-of-view. Point-of-view trigger device 415 may be any, or a combination of, a variety of different types of input device. For example, here, point-of-view trigger device 415 is an accelerometer. If the user moves computer system 400, such as by shaking or tilting system 400, point-of-view trigger device 415 may trigger and cause the appearance of the point-of-view displayed on displays 420, 422, and 424 is changed.

Besides (or in addition to) an accelerometer, point-of-view trigger device 415 can be a button, keyboard 414, a touch screen (which may be integrated with displays 420, 422), mouse 416, a tracking device that monitors a user's eye and/or body movements, a combination of any two or more of these, or other device or combination of devices.

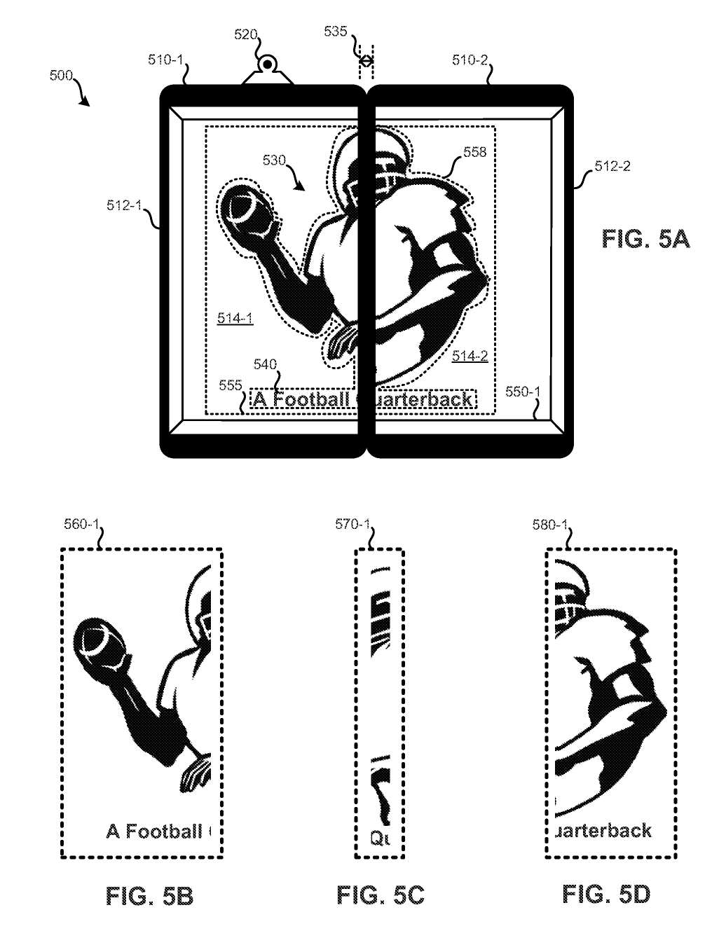

Referring to FIG. 5A, an example of system 400 is a multi-panel display system 500. Multi-panel display system 500 includes two display devices 510-1 and 510-2. Display devices 510 have frames 512 that do not display information and display panels 514 configured to display information. Display devices 510 display information, here a portion of a composite image 530 (of a football quarterback) and text 540 (stating “A Football Quarterback”). Image 530 and text 540 span display panel 514-1 and display panel 514-2. A rectangular area 555 just containing image 530 and text 540 remains constant during movement of image 530 and text 540 across display panels 514. Also, or alternatively, a perimeter 558 of image 530 and text 540 remains constant during movement. Due to a gap region 535 between display panels 514, a portion of image 530 and text 540 corresponding to gap region 535 is not displayed.

A graphic 550-1 resembles a three dimensional box. Graphic 550-1 provides the appearance that a first point-of-view is being used to observe image 530 and text 540. Graphic 550-1 provides the appearance of a point-of-view of looking straight at image 530 and text 540.

A point-of-view trigger device 520 is a retina or eye tracking device. Trigger device 520 detects movement of a user's eye and/or direction that a user is looking. Based on the movement of the user's eyes and/or direction of vision, display devices 510 may be triggered to alter the appearance of the point-of-view displayed. The change of the point-of-view depends on the indication from the trigger device 520. The indication can induce a range of different points-of-view (e.g., different angles, different perceived distances), from slight to large changes from one point-of-view to the next. Processor 430 is configured to select what information to display on display panels 514 in response to, and based on, the indication from the trigger device 520. The selected information includes the selected portions of image 530 and text 540, and the appearance of graphic 550. The selected information is based upon the desired point-of-view as indicated by the trigger device 520.

Referring to FIGS. 5B-5D, composite image 530 and text 540 include portions 560-1, 570-1, 580-1. Portion 560-1 is displayed on display panel 514-1. Portion 570-1 of image 530 and text 540 is not displayed on either display panel 514-1 or display panel 514-2. This portion of image 530 and text 540 is the part of image 530 and text 540 not displayed due to gap region 535 between display panels 514. Portion 580-1 of image 530 and text 540 is displayed on display panel 514-2.

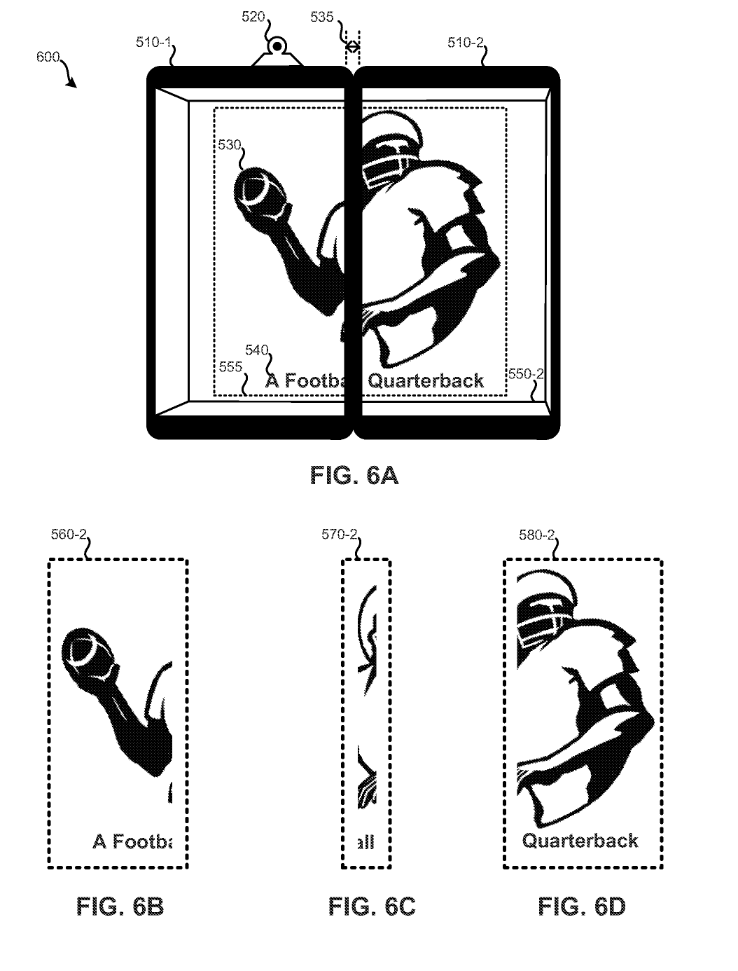

Referring to FIG. 6A, multi-panel display system 500 of FIG. 5A displays image 530 and text 540 shifted to provide an appearance of a point-of-view different from the point-of-view of FIG. 5A. Area 555 is (at least approximately) the same in FIG. 6A and FIG. 5A. Display panels 514-1 and 514-2 display image 530 and text 540 with the appearance of the point-of-view changed relative to FIG. 5A such that information that was not previously displayed (portion 570-1 of FIG. 5C) is now displayed.

A graphic 550-2 is an altered version of graphic 550-1 of FIG. 5A to give an impression that the three dimensional box (and image 530 and text 540) are being viewed from a different angle than FIG. 5A. While graphic 550-1 of FIG. 5A creates the appearance of looking straight at image 530 and text 540, graphic 550-2 of FIG. 6A provides the appearance that image 530 and text 540 are being viewed partially from the side, away from straight on.

Referring to FIGS. 6B-6D, composite image 530 and text 540 include portions 560-2, 570-2, 580-2. Portion 560-2 of image 530 and text 540 is displayed using display device 510-1. While some of portion 560-2 of image 530 and text 540 is also in portion 560-1 of FIG. 5B, some of portion 560-1 has been shifted and is now in portion 570-2. Portion 580-2, displayed using display device 510-2, includes all of the information in portion 580-1 of FIG. 5D and all of the information from portion 570-1. Portion 570-2 of FIG. 6C includes the portion of image 530 and text 540 not displayed on either display panel 514-1 or display panel 514-2 in FIG. 6A. Portion 570-2 corresponds to the part of image 530 and image 540 not displayed due to gap region 535 between display panels 514.

Portion 570-2 of FIG. 6C and portion 570-1 of FIG. 5C are different portions of image 530 and text 540. As such, when the appearance of the point-of-view is changed from the point-of-view of FIG. 5A to the point-of-view of FIG. 6A, information that was previously not displayed becomes displayed, and some information initially displayed is no longer displayed.

While FIGS. 5A and 6A illustrate display devices 510 providing the appearance of two points-of-view, the appearance of additional points-of-view may be provided. Further, the transition of graphic 550-1 from FIG. 5A to graphic 550-2 of FIG. 6A provides the appearance of the point-of-view shifting horizontally, the point-of-view may appear to move vertically or to rotate, or move as a combination of horizontal, and/or vertical, and/or rotational movement. The point-of-view may also appear to be shifted to provide the appearance of moving closer to or further away from image 530 and text 540.

Graphic 550 in FIGS. 5A and 6A provides the impression of different points-of-view by resembling a three dimensional box. Other graphics besides a graphic resembling a three dimensional box may be used to indicate the appearance of different points-of-view. For instance, letters, numbers, and/or symbols can indicate which point-of-view is being displayed. For example, graphics may remain the same except for a change in color. Additionally or alternatively, a graphic may not be present to indicate a change in the appearance of the point-of-view. Further, a sound emitted by multi-panel display system 500 may be used to indicate a change in point-of-view.

FIGS. 5A and 6A illustrate image 530 and text 540 being shifted to give the appearance of a point-of-view changing. Such shifting may not require 3D graphics to give the appearance of shifting the point-of-view. For example, 3D graphics acceleration may be used to manipulate image 530 and text 540 to provide the appearance of different points-of-view.

FIGS. 5C and 6C represent different portions of image 530 and text 540. In this example, all of the information of image 530 and text 540 is displayed between the two points-of-view shown, whether a particular portion of image 530 and text 540 is in the point-of-view of FIG. 5A, FIG. 6A, or both. In other examples, the appearance of the point-of-view may be shifted by an amount that is insufficient for all of the information to be displayed in the combined points-of-view. In such instances, portions of the non-displayed information, such as portions 570-1, 570-2, will contain some of the same information.

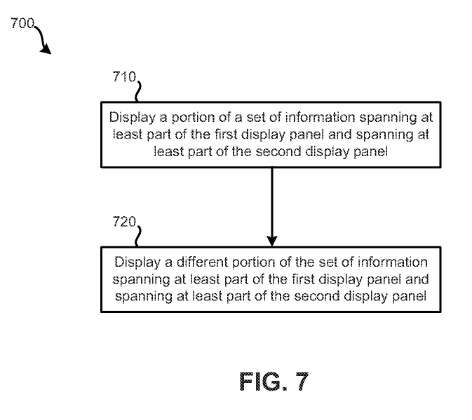

Referring to FIG. 7, with further reference to FIGS. 1-6, a process 700 of displaying information across multiple display panels includes the stages shown. The process 700 is, however, an example only and not limiting. The process 700 can be altered, e.g., by having stages added, removed, rearranged, combined, and/or performed concurrently.

At stage 710, a portion of a set of information is displayed spanning at least part of a first display panel and spanning at least part of a second display panel. The set of information has fixed dimensions, e.g., perimeter, such that the dimensions of the information remains constant or approximately constant regardless of whether and how the information is displayed on one or more than one display panel. A portion of the set of information is not displayed. This portion of information not displayed corresponds to a gap region between the first display panel and the second display panel.

At stage 720, a different portion of the set of information spanning at least part of the first display and spanning at least part of the second display panel is displayed. The portion of the set of information not displayed at stage 710 is at least partially displayed at stage 720. A portion of the set of information is not displayed at stage 720. Again here, this portion of information corresponds to the gap region between the first display panel and the second display panel. This undisplayed portion is at least partially different from the previously undisplayed information at stage 720.

An indication may be provided to a user at stages 710 and 720 to indicate the appearance of different points-of-view. Therefore, when stage 720 is performed, a user may see what appears to be a different point-of-view of the set of information from the appearance of a point-of-view at stage 710. The indication may provide visual assistance or a visual guide to give the appearance of a different point-of-view and/or may label the information as different (e.g., “front view” versus “side view”).

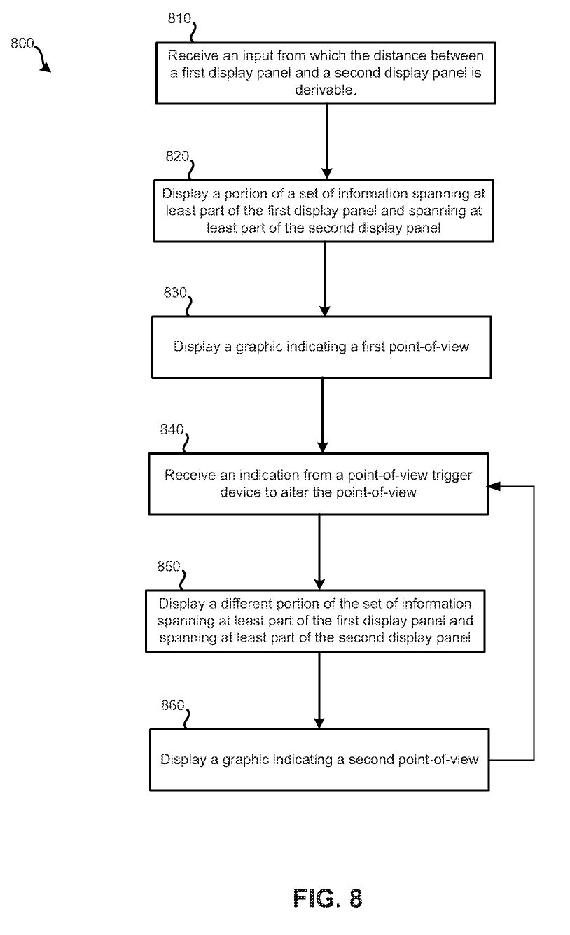

Referring to FIG. 8, with further reference to FIGS. 1-6, a process 800 of displaying information across multiple display panels includes the stages shown. The process 800 is, however, an example only and not limiting. The process 800 can be altered, e.g., by having stages added, removed, rearranged, combined, and/or performed concurrently.

At stage 810, an input indicating the distance between a first display panel and a second display panel is received. Stage 810 is preferably performed if the distance between the display panels is not fixed. For example, a user may arrange monitors 240 varying distances apart. In such a situation, the user provides an input (such as a distance, display device model number(s)) indicating the size of the gap region between a first display panel and a second display panel (or all gaps if more than two display panels are being used). Stage 810 may be omitted if the size of the gap region is fixed, such as gap region 130 of FIG. 1. The input can be other than a user-provided distance. For example, the input could be a device model number (or numbers) from which frame dimensions can be determined (e.g., found by a processor accessing a lookup table stored in memory). Still other inputs are possible from which gap dimensions can be determined or partially determined. Information can be supplied from which frame dimensions can be determined, and that indicate separation of the frames. Further, information can be provided indicating non-uniform separation of display devices (e.g., different horizontal and vertical separations, varying vertical separation and/or varying horizontal separation, etc.).

At stage 820, a portion of a set of information spanning at least part of the first display panel and spanning at least part of the second display panel is displayed. Another portion of the set of information not displayed corresponds to a gap region between the first display panel and the second display panel. At stage 830, while the portion of the set of information indicated at stage 820 is being displayed, a graphic is displayed that indicates a first-point-of-view. This graphic may provide the appearance of a three dimensional box.

At stage 840, an indication is received from a point-of-view trigger device to alter the point-of-view. Based on the indication received from the point-of-view trigger device, the portion of the set of information and the graphic indicating the point-of-view displayed at stages 820 and 830, respectively, are changed. For example, an accelerometer detects acceleration and provides the indication as a magnitude and direction of acceleration of the system (e.g., a mobile phone).

At stage 850, a different portion (relative to stage 820) of the set of information spanning at least part of the first display panel and spanning at least part of the second display panel is displayed. The different portion of the set of information is selected (e.g., by a processor) based on the indication from the trigger device. This portion of the set of information contains at least some of the portion of the set of information that was not displayed at stage 820. Another (at least partially different) portion of the set of information, relative to stage 820, is not displayed at stage 850. This undisplayed portion of the set of information corresponds to the gap region between the first display panel and the second display panel. Some of the portion of the set of information displayed at stage 820 may also be displayed at stage 850. At stage 860, the graphic indicating a first point-of-view displayed at stage 830 is altered to a graphic indicating a second point-of-view. If the graphic gives the appearance of a three dimensional box, the shape of the graphic is altered such that it appears that the three dimensional box is being viewed from a different angle and/or distance.

Method 800 returns to stage 840 for further point-of-view changes. As new indications of different desired points-of-view are received (e.g., tilting of a phone, movement of a user's eyes, etc.) are received, the point-of-view displayed is changed. This continues until a resetting event occurs, such as the image being removed, the computer system being turned off, etc. Once the resetting occurs, method 800 will restart at stage 810.

The methods, systems, and devices discussed above are examples and not limiting. Various embodiments may omit, substitute, or add various procedures or components as appropriate. For instance, features described with respect to certain embodiments may be combined in various other embodiments. Different aspects and elements described above as being separate or in different embodiments may be combined.

Specific details are given in the description to provide a thorough understanding of example configurations and implementations. Other examples may or may not use these specific details. For example, well-known circuits, processes, algorithms, structures, and techniques have been shown without unnecessary detail in order to avoid obscuring the description.

Operations described above in a sequential process may be performed in a different sequence, and operations can be omitted or added to the processes described, and/or may be performed concurrently. Furthermore, processes described above may be implemented by hardware, software executed by a processor, firmware, middleware, microcode, hardware description languages, or any combination thereof. When implemented in software, firmware, middleware, or microcode, the program code or code segments to perform the operations may be stored in a non-transitory computer-readable medium such as a storage medium. One or more processors can execute the software to perform the appropriate tasks.

Various modifications, alternative constructions, and equivalents may be used without departing from the spirit of the disclosure. For example, elements described above may be components of a larger system, where other rules may take precedence over or otherwise modify the description. Also, a number of steps may be undertaken before, during, or after the above elements are considered. Accordingly, the above description is not limiting of the disclosure and does not define the bounds of the claims.

Other examples and implementations are within the scope and spirit of the disclosure and appended claims. Features implementing functions may be physically located at various positions, including being distributed such that portions of functions are implemented at different physical locations.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Further, more than one invention may be disclosed.

What is claimed is:

1. A system comprising:
a processor configured to be communicatively coupled to a first display panel and to a second display panel, the second display panel being located a first distance from the first display panel, wherein the processor is configured to:
display, using the first display panel and the second display panel, a first portion of a set of information over a display region spanning at least part of the first display panel and spanning at least part of the second display panel, wherein:
the set of information has boundary dimensions; and
the first portion excludes a second portion of the set of information corresponding to a gap region between the first panel and the second panel, with the first portion having the boundary dimensions.

2. The system of claim 1, wherein the processor is further comprised to: display, using the first display panel and the second display panel, a third portion of the set of information over the display region spanning at least part of the first display panel and at least part of the second display panel, wherein:
the third portion of the set of information excludes a fourth portion of the set of information corresponding to the gap region between the first display panel and the second display panel with the third portion having the boundary dimensions; and
the fourth portion of the set of information and the second portion are at least partially different portions of the set of information.

3. The system of claim 2, wherein the processor is further configured to:
display, using the first display panel and the second display panel, a first graphic while displaying the first portion, wherein the first graphic indicates a first point-of-view; and
display, using the first display panel and the second display panel, a second graphic while displaying the third portion, wherein the second graphic indicates a second point-of-view that is different from the first point-of-view.

4. The system of claim 3, wherein:
the first graphic displayed while displaying the first portion provides an appearance of the first point-of-view; and
the second graphic displayed while displaying the third portion provides an appearance of the second point-of-view.

5. The system of claim 2, wherein:
the fourth portion and the second portion are exclusively different portions of the set of information;
the third portion comprises at least some of the information of the second portion; and
the fourth portion comprises at least some of the information of the first portion.

6. The system of claim 2, further comprising a point-of-view trigger device communicatively coupled with the processor, wherein:
the point-of-view trigger device is configured to provide an indication to the processor; and
the processor is configured to use the indication to determine whether to display the first portion of the set of information or to display the third portion of the set of information.

7. The system of claim 6, wherein the point-of-view triggering device is an accelerometer.

8. The system of claim 6, wherein the point-of-view triggering device comprises at least one of a retina tracking device, a touchpad, a touch screen, a keyboard, or a button.

9. The system of claim 2, wherein the processor is further configured to:
display the first portion over the display region spanning the first display panel, the second display panel, and a third display panel located a second distance from the second display panel, wherein the second portion further comprises information corresponding to a second gap region between the second display panel and the third panel; and
display the third portion over the display region spanning the first display panel, the second display panel, and the third display panel, wherein the fourth portion further comprises information corresponding to the second gap region between the second display panel and the third panel.

10. The system of claim 2, wherein the processor is further configured to:
receive an input;
determine the first distance from the first display panel to the second display panel using the input; and
determine information in the third portion and information in the fourth portion based on the first distance.

11. The system of claim 1, wherein the system comprises a mobile telecommunications device and wherein the first and second display panels are movably connected such that the first display panel can be moved from a first position coplanar with the second display panel to a second position overlying the second display panel.

12. A method for displaying information, the method comprising:
displaying, using a first display panel and a second display panel, a first portion of a set of information over a display region spanning at least part of the first display panel and spanning at least part of the second display panel, the first display panel located a first distance from the second display panel, wherein:
the set of information has boundary dimensions; and
the first portion excludes a second portion of the set of information corresponding to a gap region between the first panel and the second panel, with the first portion having the boundary dimensions.

13. The method of claim 12, further comprising:
displaying, using the first display panel and the second display panel, a third portion of the set of information over the display region spanning at least part of the first display panel and at least part of the second display panel, wherein:
the third portion of the set of information excludes a fourth portion of the set of information corresponding to the gap region between the first display panel and the second display panel with the third portion having the boundary dimensions; and
the fourth portion of the set of information and the second portion are at least partially different portions of the set of information.

14. The method of claim 13, further comprising:
displaying, using the first display panel and the second display panel, a first graphic while displaying the first portion, wherein the first graphic indicates a first point-of-view; and
displaying, using the first display panel and the second display panel, a second graphic while displaying the third portion, wherein the second graphic indicates a second point-of-view that is different from the first point-of-view.

15. The method of claim 13, wherein:
the first graphic is displayed while displaying the first portion provides an appearance of the first point-of-view; and
the second graphic is displayed while displaying the third portion provides an appearance of the second point-of-view.

16. The method of claim 13, wherein:
the fourth portion and the second portion are exclusively different portions;
the third portion comprises at least some of the information of the second portion; and
the fourth portion comprises at least some of the information of the first portion.

17. The method of claim 13, further comprising:
receiving an indication from a point-of-view trigger device; and
selecting the third portion of the set of information based on the indication.

18. The method of claim 17, further comprising:
detecting an acceleration; and
providing the indication indicating a direction and magnitude of the acceleration.

19. The method of claim 13, further comprising:
displaying the first portion over the display region spanning the first display panel, the second display panel, and a third display panel located a second distance from the second display panel, wherein the second portion further comprises information corresponding to a second gap region between the second display panel and the third panel; and
displaying the third portion over the display region spanning the first display panel, the second display panel, and the third display panel, wherein the fourth portion further comprises information corresponding to the second gap region between the second display panel and the third panel.

20. The method of claim 13, further comprising:
receiving an input;
determining the first distance from the first display panel to the second display panel using the input; and
determining information in the third portion and information in the fourth portion using the first distance.

21. A computer program product residing on a non-transitory processor-readable medium and comprising processor-readable instructions configured to cause a processor to:
display, using a first display panel and a second display panel, a first portion of a set of information over a display region spanning at least part of the first display panel and spanning at least part of the second display panel, the first display panel located a first distance from the second display panel, wherein:
the set of information has boundary dimensions; and
the first portion excludes a second portion of the set of information corresponding to a gap region between the first panel and the second panel, with the first portion having the boundary dimensions.

22. The computer program product of claim 21, further comprising processor-readable instructions configured to cause the processor to display, using the first display panel and the second display panel, a third portion of the set of information over the display region spanning at least part of the first display panel and at least part of the second display panel, wherein:
the third portion of the set of information excludes a fourth portion of the set of information corresponding to the gap region between the first display panel and the second display panel with the third portion having the boundary dimensions; and
the fourth portion of the set of information and the second portion are at least partially different portions of the set of information.

23. The computer program product of claim 22, further comprising processor-readable instructions configured to cause the processor to:
display a first graphic while displaying the first portion, wherein the first graphic indicates a first point-of-view; and
display a second graphic while displaying the third portion, wherein the second graphic indicates a second point-of-view that is different from the first point-of-view.

24. The computer program product of claim 23, wherein:
the first graphic displayed while displaying the first portion provides an appearance of the first point-of-view; and
the second graphic displayed while displaying the third portion provides an appearance of the second point-of-view.

25. The computer program product of claim 22, wherein:
the fourth portion of the set of information and the second portion of the set of information are exclusively different portions;
the third portion of the set of information comprises at least some of the information of the second portion of the set of information; and
the fourth portion of the set of information comprises at least some of the information of the first portion of the set of information.

26. The computer program product of claim 22, further comprising processor-readable instructions configured to cause the processor to:
display the first portion over the display region spanning the first display panel, the second display panel, and a third display panel located a second distance from the second display panel, wherein the second portion further comprises information corresponding to a second gap region between the second display panel and the third panel; and
display the third portion over the display region spanning the first display panel, the second display panel, and the third display panel, wherein the fourth portion further comprises information corresponding to the second gap region between the second display panel and the third panel.

27. The computer program product of claim 22, further comprising processor-readable instructions configured to cause the processor to:
receive an input;
determine the first distance using the input; and
determine information in the third portion and information in the fourth portion using the first distance.

28. A system comprising:
means for displaying a first portion of a set of information over a display region spanning at least part of a first display panel and spanning at least part of a second display panel, the first display panel located a first distance from the second display panel, wherein:
the set of information has boundary dimensions;
the first portion excludes a second portion of the set of information corresponding to a gap region between the first panel and the second panel, with the first portion having the boundary dimensions.

29. The system of claim 28, further comprising:
means for displaying a third portion of the set of information over the display region spanning at least part of the first display panel and at least part of the second display panel, wherein:
the third portion of the set of information excludes a fourth portion of the set of information corresponding to the gap region between the first display panel and the second display panel with the third portion having the boundary dimensions; and
the fourth portion of the set of information and the second portion are at least partially different portions of the set of information.

30. The system of claim 29, further comprising:
means for displaying a first graphic while displaying the first portion of the set of information, wherein the first graphic indicates a first point-of-view; and
means for displaying a second graphic while displaying the third portion of the set of information, wherein the second graphic indicates a second point-of-view that is different from the first point-of-view.

31. The system of claim 30, wherein:
the first graphic displayed while displaying the first portion provides an appearance of the first point-of-view; and
the second graphic displayed while displaying the third portion provides an appearance of the second point-of-view.

32. The system of claim 29, wherein:
the fourth portion and the second portion are exclusively different portions;
the third portion comprises at least some of the information of the second portion; and
the fourth portion comprises at least some of the information of the first portion.

33. The system of claim 29, further comprising means for determining whether to display the first portion of the set of information or to display the third portion of the set of information.

34. The system of claim 29, further comprising:
means for displaying the first portion over the display region spanning the first display panel, the second display panel, and a third display panel located a second distance from the second display panel, wherein the second portion further comprises information corresponding to a second gap region between the second display panel and the third panel; and
means for displaying the third portion over the display region spanning the first display panel, the second display panel, and the third display panel, wherein the fourth portion further comprises information corresponding to the second gap region between the second display panel and the third panel.

35. The system of claim 29, further comprising:
means for receiving an input;
means for determining the first distance using the input; and
means for determining information in the third portion and information in the fourth portion using the first distance.

36. The system of claim 28, wherein the system comprises a mobile telecommunication device.

37. A multi-panel display system, comprising:
a first display panel configured to display information;
a second display panel configured to display information, wherein the second display panel is located a distance from the first display panel; and
a processor communicatively coupled to the first display panel and the second display panel, wherein the processor is configured to:
display, using the first display panel and the second display panel, a first portion of a set of information over a display region spanning at least part of the first display panel and spanning at least part of the second display panel, wherein:
the set of information has boundary dimensions; and
the first portion excludes a second portion of the set of information corresponding to a gap region between the first panel and the second panel, with the first portion having the boundary dimensions.

38. The multi-panel display system of claim 37, wherein the processor is further configured to:
display, using the first display panel and the second display panel, a third portion of the set of information over the display region spanning at least part of the first display panel and at least part of the second display panel, wherein:
the third portion of the set of information excludes a fourth portion of the set of information corresponding to the gap region between the first display panel and the second display panel with the third portion having the boundary dimensions; and
the fourth portion of the set of information and the second portion are at least partially different portions of the set of information.

39. The multi-panel display system of claim 38, wherein the processor is further configured to:
display a first graphic while displaying the first portion of the set of information, wherein the first graphic indicates a first point-of-view; and
display a second graphic while displaying the third portion of the set of information, wherein the second graphic indicates a second point-of-view that is different from the first point-of-view.

40. The multi-panel display system of claim 39, wherein:
the first graphic displayed while displaying the first portion provides an appearance of the first point-of-view; and
the second graphic displayed while displaying the third portion provides an appearance of the second point-of-view.

41. The multi-panel display system of claim 38, further comprising a point-of-view trigger device communicatively coupled with the processor, wherein:
the point-of-view trigger device is configured to provide an indication to the processor; and
the processor is configured to use the indication to determine whether to display the first portion of the set of information or to display the third portion of the set of information.

42. The multi-panel display system of claim 41, wherein the point-of-view triggering device comprises at least one of an accelerometer, a retina tracking device, a touchpad, a touch screen, a keyboard, or a button.

43. The multi-panel display system of claim 38, further comprising a third display panel configured to display information, wherein the processor is further configured to:
display the first portion over the display region spanning the first display panel, the second display panel, and a third display panel, wherein the second portion further comprises information corresponding to a second gap region between the second display panel and the third panel; and
display the third portion over the display region spanning the first display panel, the second display panel, and the third display panel, wherein the fourth portion further comprises information corresponding to the second gap region between the second display panel and the third panel.

44. The multi-panel display system of claim 43, wherein the system comprises a mobile telecommunications device and wherein the first display panel, the second display panel, and the third display panel are configured to be disposed in a coplanar relationship.

45. The multi-panel display system of claim 37, further comprising first and second housings, of the first and second display panels respectively, occupying at least a portion of the distance between the first display panel and the second display panel.

46. The multi-panel display system of claim 37, further comprising a plurality of display panels in addition to the first display panel and the second display panel.

47. The multi-panel display system of claim 46, wherein the first display panel, the second display panel, and the plurality of display panels are arranged one of linearly or in a two-dimensional array.
